(19) United States
(12) Patent Application Publication
(10) Pub. No.: US 2023/0016397 A1
(43) Pub. Date: Jan. 19, 2023

(54) SYSTEM AND METHOD TO PREDICT AND PREVENT CUSTOMER CHURN IN SERVICING BUSINESS

(71) Applicant: Toshiba TEC Kabushiki Kaisha, Shinagawa-ku (JP)

(72) Inventor: Marianne KODIMER, Huntington Beach, CA (US)

(21) Appl. No.: 17/378,121

(22) Filed: Jul. 16, 2021

(51) Int. Cl. G06Q 30/00; G06Q 10/00; G06Q 30/02; H04N 1/00

(52) U.S. Cl. CPC G06Q 30/016; G06Q 30/018; G06Q 10/20; G06Q 30/012; G06Q 30/0234; H04N 1/00411; H04N 1/0009; H04N 1/00029; H04N 1/00076; G06N 20/00

(57) ABSTRACT

A system and method for minimizing customer churn in device service businesses commences with execution of a customer service contract. Ongoing customer data capture is made for each contract. Customer data includes contract events, environmental events, service events, device usage analytics and personnel events. Machine learning is applied to captured customer data, which machine learning is based on a state of customer data at the time of contract determination. Customer data is assigned weights, and aggregate data for each customer is compared to a preselected threshold level. Customers above a threshold are deemed happy and customers below the threshold are deemed to be at risk. Remedial measures relative to at risk customer data generates remedial measure suggestions.

### TECHNICAL FIELD

This application relates generally to monitoring events relative to a service contract to gage a customer satisfaction level. The application relates more particularly to an artificial intelligence system that predicts when a low customer satisfaction level may lead to contract termination and suggests remedial actions to raise the customer's satisfaction level.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Business having one or more MFPs often enter into service contracts with a dealer or other service entity. Customer churn (or attrition) is a rate at which customers abandon a brand or servicing business. It more expensive and difficult to acquire a new customer than to retain an existing one. Companies may use customer feedback and surveys to collect data that may help to provide insights into customer satisfaction and causes of dissatisfaction and attrition. However, resulting data is limited and reveals only obvious causes of customer dissatisfaction.

### BRIEF DESCRIPTION OF THE DRAWINGS

Various embodiments will become better understood with regard to the following description, appended claims and accompanying drawings wherein:

FIG. 1 an example embodiment of a system to predict and prevent customer churn in a servicing business;

FIG. 2 is an example embodiment of a networked digital device such as a multifunction peripheral;

FIG. 3 is an example embodiment of a digital device system such as a server;

FIG. 4 is an example embodiment showing datapoints for customer or contract events for analysis;

FIG. 5 illustrates block diagram for a system to predict and prevent customer churn in a servicing business;

FIG. 6 illustrates a flowchart of an example embodiment of system to predict and prevent customer churn in a servicing business; and

FIG. 7 is an example embodiment of a graphical rendering of attrition correlation.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Example embodiments herein predict when a customer will leave so an associated servicing company can make additional efforts to retain the customer and also change the current business practices and processes to preemptively maintain customer satisfaction. Big data and artificial intelligence (AI), which may comprise machine learning (ML), is used to systematically collect analytics from a large array of aspects of an MFP servicing business, beginning with contract commencement, to find corollary relationships and patterns between events and attrition, as well as events and retention, over an entire course of the customer-servicing business relationship. Analytics are employed to gather data from a variety of sources to find correlations between events and attrition/retention.

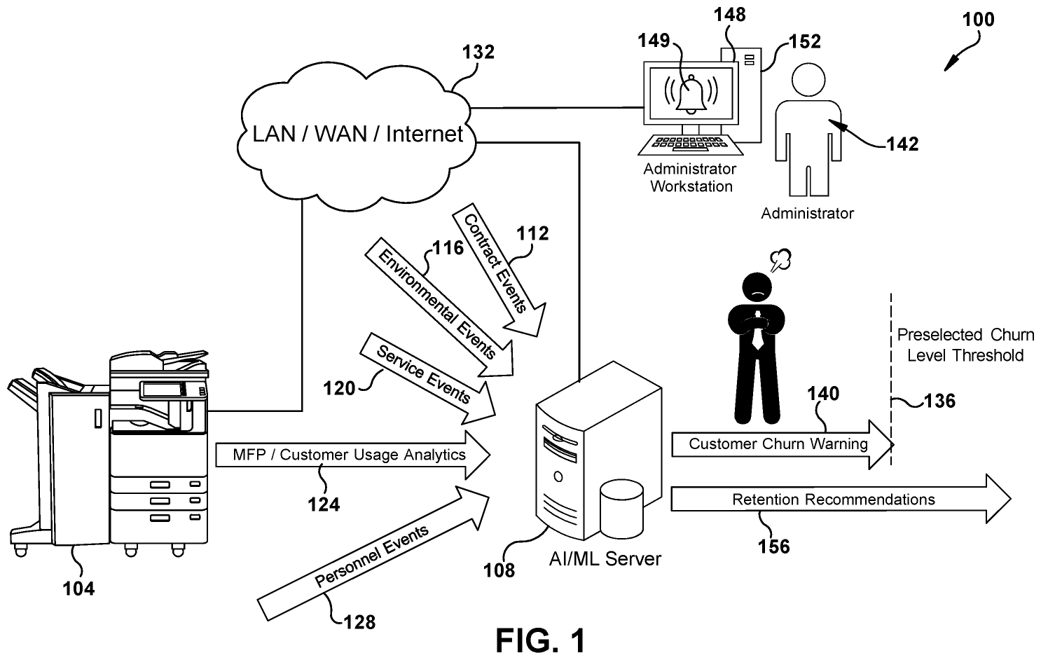

FIG. 1 illustrates an example embodiment of a system 100 to predict and prevent customer churn in a servicing business. One or more MFPs, such as MFP 104, are associated with a device service contract. For each service contract, an AI/ML server receives and stores customer data, comprising customer events associated with the contract. Customer data may include contract events 112, environmental events 116, service events 120, MFP/customer usage analytics 124 and personnel events 128. Certain customer service information, such as MFP/customer usage analytics, such as error codes, copy counts or toner levels, is suitably acquired from each MFP associated with a contract via network cloud 132. Network cloud 132 is suitably comprised of a local area network (LAN), a wide area network (WAN), which may comprise the Internet, or any suitable combination thereof.

Machine learning is applied to stored customer service information to gage a customer's satisfaction level. When a customer's satisfaction level falls below a preselected threshold 136, a customer churn warning 140 is generated and displayed to administrator 142, suitably generating a notification or alarm 149 on a display 148 of an administrator workstation 152. Possible remedial actions associated with customer events are stored in server 108 and suitably displayed for each contract subject to a customer churn warning. An alarm is any suitable audible, visual or haptic notification, and may also comprise an e-mail to an administrator.

Server 108 includes any suitable AI/ML system, such as TensorFlow, Google Cloud ML Engine, Amazon Machine Learning (AML), Accord.net, Apache Mahout, or any other suitable platform.

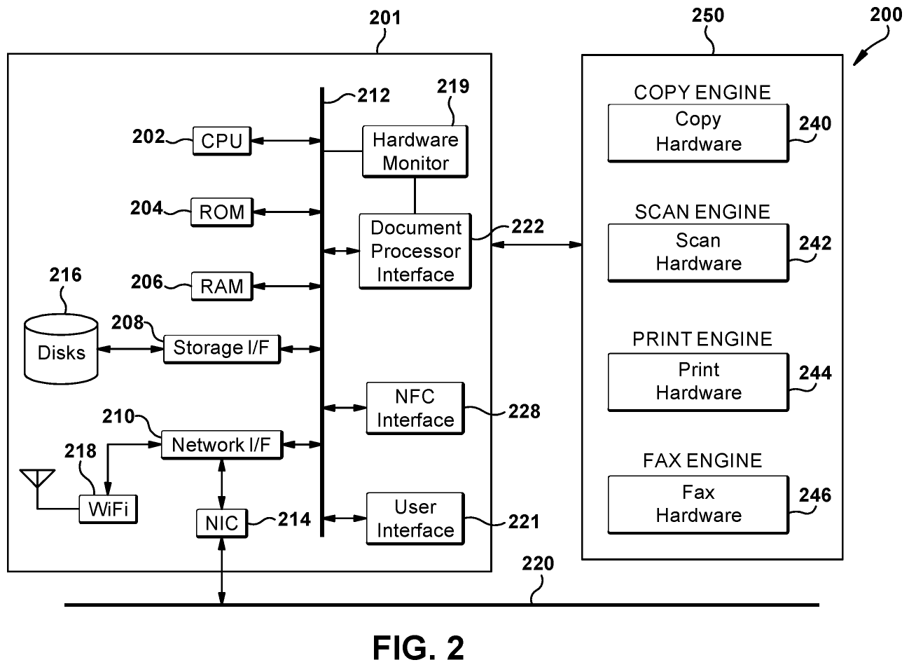

Turning now to FIG. 2, illustrated is an example embodiment of a networked digital device comprised of document rendering system 200 suitably comprised within an MFP, such as with MFPs 104 of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Processor 202 is also in data communication with hardware monitor 219, suitably comprised of counters, toner, paper or ink level sensors, temperature sensors, error condition sensors, paper jam sensors or the like. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 221 for interfacing with displays, keyboards, touchscreens, mice, trackballs and the like.

Also in data communication with data bus 212 is a document processor interface 222 suitable for data communication with the document rendering system 200, including MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

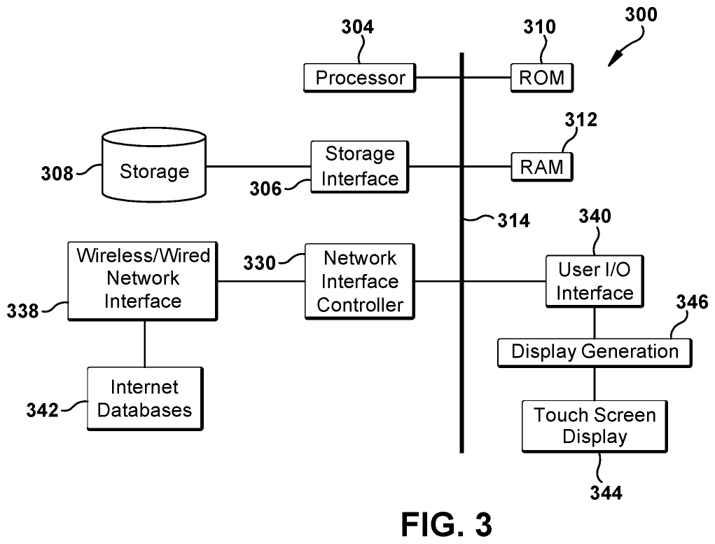

Turning now to FIG. 3, illustrated is an example embodiment of a digital data processing device 300 such as server 108 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Storage 308 includes stored contract records, personnel records, service records, and the like. A network interface controller 330 suitably provides a gateway for data communication with other devices, such as via wireless network interface 338. A user input/output interface 340 suitably provides display generation 346 providing a user interface via touchscreen display 344, suitably displaying images from display generator 346. It will be understood that the computational platform to realize the system as detailed further below is suitably implemented on any or all of devices as described above. Network Interface 338 is suitably connected to the Internet for access to Internet databases 342 from which event data, such as environmental events.

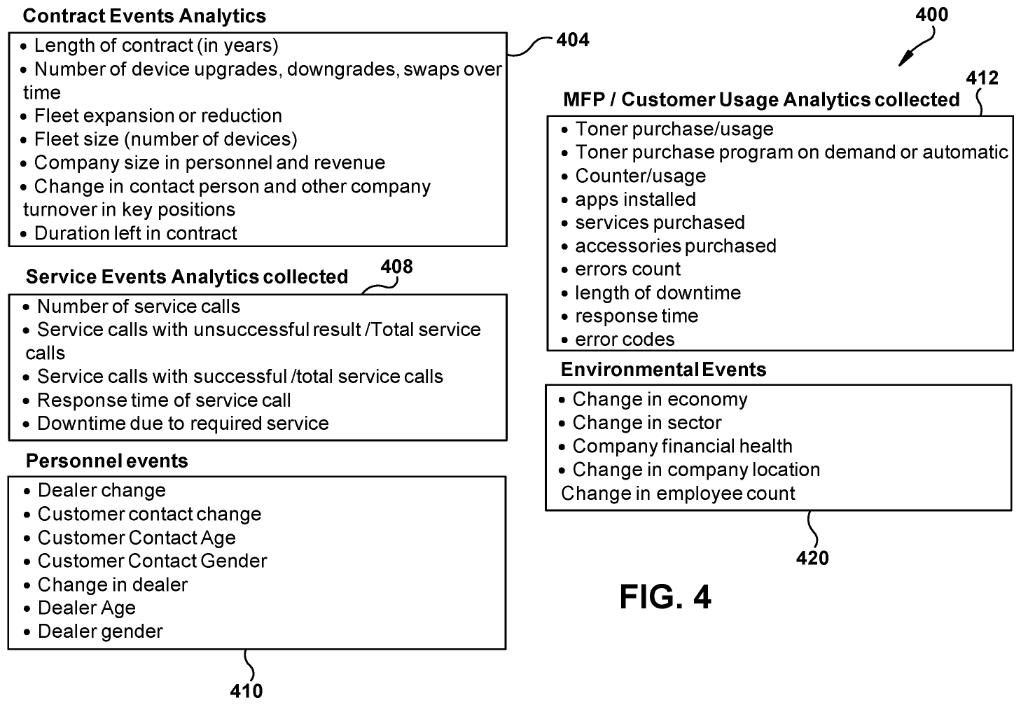

Referring next to FIG. 4, illustrated is an example embodiment showing datapoints 400 for customer or contract events for analysis which are suitably gathered from the inception of customer contract. Analytics are gathered from a variety of sources including those pertaining to the purchasing and servicing contract, servicing events, customer usage, environmental factors, and personnel events. The following categorization and analytics are obtained over time:

Contract Events Analytics 404:
Length of contract (in years)
Number of device upgrades, downgrades, swaps over time
Fleet expansion or reduction
Fleet size (number of devices)
Company size in personnel and revenue
Change in contact person and other company turnover in key positions
Duration left in contract

Service Events Analytics collected 408:
Number of service calls
Service calls with unsuccessful result/Total service calls
Service calls with successful/total service calls
Response time of service call
Downtime due to required service

Personnel events 410:
Dealer change
Customer contact change
Customer Contact Age
Customer Contact Gender
Change in dealer
Dealer Age
Dealer gender

MFP/Customer Usage Analytics collected 412:
Toner purchase/usage
Toner purchase program on demand or automatic
Counter/usage
apps installed
services purchased
accessories purchased
errors count
length of downtime
response time
error codes

Environmental Events 420:
Change in economy
Change in sector
Company financial health
Change in company location
Change in employee count

Multivariate analysis, and pattern recognition is used on collected data such that those factors that alone, or in combination, are correlated to predict churn in existing customers. This allows a company to determine whether a current/future customer is likely to discontinue services. When the prediction threshold is reached, service and sales employees can intervene to save a customer.

Data, such as that detailed above, can serve to change current processes and areas of focus. For example, if the frequency of error code for paper jams correlates highly with churn, it will allow a manufacturer to invest in technology to minimize the occurrence in paper jams over another error that is not correlated with attrition.

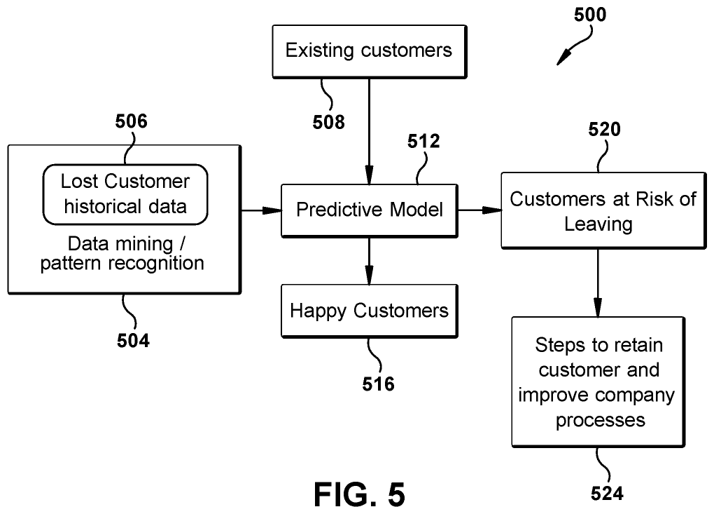

FIG. 5 illustrates block diagram for a system 500 to predict and prevent customer churn in a servicing business. Data mining and pattern recognition is made from customer data, such as the event data listed above, along with historical event data for lost customers illustrated at block. Data from block 504 is fed, along with data from existing customers at block 508, to predictive model 512. Predictive model 512 categorizes customers as happy customers at block 516 or customers at risk of leaving at block 520. Customers at risk of leaving are provided with remedial activity from block 524.

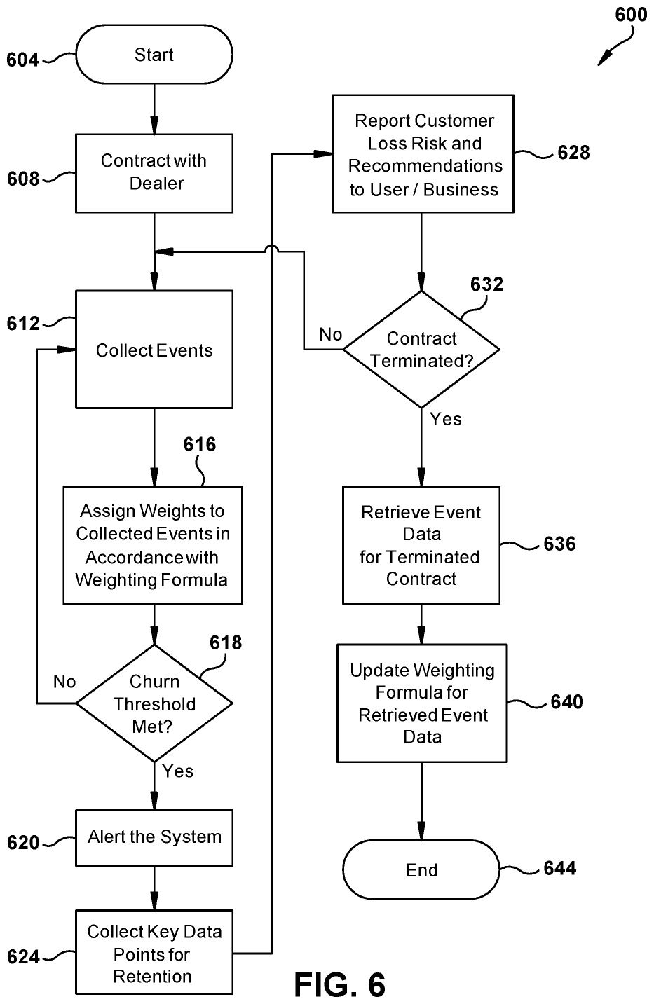

FIG. 6 illustrates flowchart 600 of an example embodiment of system to predict and prevent customer churn in a servicing business. The process commences at block 604 and proceeds to block 608 when a customer enters into a service contract with a dealer. Event data is collected at block 612 where it is subjected to AI/ML and weights are assigned to various events. A test of event weights is made for each customer contract at block 618 relative to a preselected threshold value. If the threshold is not exceeded, the process returns to block 612. If a threshold is met, an alert is generated at block 620 and key data points for retention are collected at block 624. A report is generated, along with recommendations corresponding to data for an at risk customer, at block 628. Example remedial measures may include customer meetings, contract price adjustment, price rebates, customer gifts, device replacement, software upgrades, or hardware upgrades.

If a contract was not terminated as determined at block 632, the process returns to block 612. If terminated, event data for the terminated contract is gathered at block 636 and provides for updated AI/ML at block 640. The process then ends at block 644.

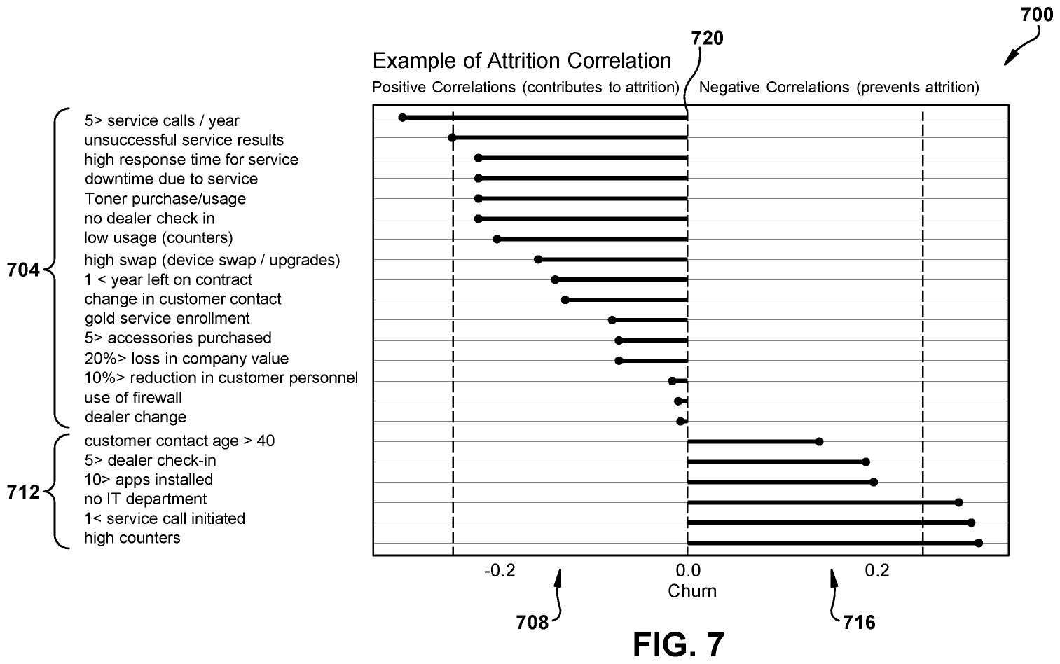

FIG. 7 is an example embodiment of graphical rendering attrition correlation 700. Positive correlations 704, illustrated with weighted values are illustrated at 708. Positive correlations are those that may contribute to customer attrition. Negative correlations 712, illustrated with weighted values are illustrated at 716. Churn is determined when correlations exceed threshold

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor;
memory storing customer data corresponding to ongoing events associated with a multifunction peripheral;
the processor configured to assign a satisfaction weight to each event;
the processor further configured to aggregate assigned satisfaction weights to generate a churn level, wherein negative satisfaction weights correspond to negative customer experiences and positive satisfaction weights correspond to positive customer experiences; and
the processor further configured to generate a customer churn warning to an associated user when an aggregated satisfaction weight crosses a preselected threshold level.

2. The system of claim 1 wherein the memory further stores remedial suggestions associated with the events and wherein the processor is further configured to output, to a display, one or more remedial suggestions to the associated user in accordance with the events having negative satisfaction weights.

3. The system of claim 2 wherein the customer data is comprised of one or more of contract events, environmental events, service events, customer usage analytics and personnel events.

4. The system of claim 3 wherein the processor is further configured to:
receive input corresponding to loss of a customer; and
update assigned satisfaction weights in accordance with event satisfaction weights for the events associated with the customer.

5. The system of claim 4 further comprising:
a usage meter configured to generate usage data corresponding to operation of the multifunction peripheral; and
the memory configured to store error codes associated with operation of the multifunction peripheral;
wherein the customer data includes customer usage comprised of the usage data and the error codes.

6. The system of claim 5 wherein the usage data is comprised of a page count.

7. The system of claim 6 wherein the customer data includes service events associated a service record for the multifunction peripheral.

8. A method comprising:
storing, in a memory, customer data corresponding to ongoing events associated with a multifunction peripheral;
assigning a satisfaction weight to each event;
aggregating assigned satisfaction weights to generate a churn level, wherein negative satisfaction weights correspond to negative customer experiences and positive satisfaction weights correspond to positive customer experiences; and
generating a customer churn warning to an associated user when an aggregated satisfaction weight crosses a preselected threshold level.

9. The method of claim 8 further comprising:
storing, in the memory, remedial suggestions associated with the events; and
displaying one or more remedial suggestions to the associated user in accordance with the events having negative satisfaction weights.

10. The method of claim 9 wherein the customer data is comprised of one or more of contract events, environmental events, service events, customer usage analytics and personnel events.

11. The method of claim 8 further comprising:
receive input corresponding to loss of a customer; and
updating assigned satisfaction weights in accordance with event satisfaction weights for the events associated with the customer.

12. The method of claim 11 further comprising:
generating usage data corresponding to operation of the multifunction peripheral; and
the memory configured to store error codes associated with operation of the multifunction peripheral; and
wherein the customer data includes customer usage comprised of usage data and the error codes.

13. The method of claim 12 wherein the usage data is comprised of a page count.

14. The method of claim 13 wherein the customer data includes service events associated a service record for the multifunction peripheral.

15. A system comprising:
a memory storing, for each of a plurality of multifunction peripheral service contracts, customer data comprising,
contract events including a service contract commencement date,
environmental events,
service events including a device service record,
usage analytics, including a device page count and device error codes, and personnel events; and
a processor configured, for each service contract,
assign a satisfaction weight to each event,
determine an aggregate satisfaction level in accordance with assigned satisfaction weights,
generate a notification on an associated display when a determined aggregate satisfaction level is below a preselected threshold level.

16. The system of claim 15 wherein the memory further stores remedial suggestions associated with events, and wherein the processor is further configured to show, on an associated display, remedial suggestions associated with customer data for each service contract for which a notification is generated.

17. The system of claim 16 further comprising:
a user interface configured to receive input indicating a termination of one or more service contracts;
the processor further configured to update assigned satisfaction weights in accordance with event satisfaction weights for the events associated each terminated service contract.

18. The system of claim 17 wherein the remedial suggestions comprise one or more of:
customer meetings,
contract price adjustment,
price rebates,
customer gifts,
device replacement,
software upgrades, and
hardware upgrades.

19. The system of claim 18 wherein the processor is furthered to receive the usage analytics for each multifunction peripheral associated with a service contract via a network interface.

20. The system of claim 19 wherein the notification is comprised of a visible, audible or haptic alarm.
